(19) United States
(12) Patent Application Publication
(10) Pub. No.: US 2005/0233074 A1
(43) Pub. Date: Oct. 20, 2005

(54) Solid flowable powder with high liquid loading

(76) Inventors: Sean Mark Dalziel, Wilmington, DE (US); Prathibha Laxman Gai, Wilmington, DE (US); Thomas E. Friedmann, Hockessin, DE (US); Qian Qiu Zhao, Hockessin, DE (US); George A. Schurr, Newark, DE (US)

Correspondence Address: E I du Pont de Nemours & Company, Legal Patents, Wilmington, DE, 19898, US

(21) Appl. No.: 10/521,002

(22) PCT Filed: Aug. 14, 2003
(86) PCT No.: PCT/US03/25882

§ 371 Date: Jan. 7, 2005

Related U.S. Application Data
(60) Provisional application No. 60/403,489, filed on Aug. 14, 2002.

(51) Int. Cl. B05D 7/00

(52) U.S. Cl. 427/212; 427/233

(57) ABSTRACT

A process of manufacturing compositions comprised of carrier particles under 100 nm that have been loaded to a level of greater than 60% by weight with a liquid. The highly-liquid-loaded particles can be further coated or encapsulated with functional coating or encapsulating materials.

This application claims the benefit of U.S. Provisional Application No. 60/403,489, filed Aug. 14, 2002.

### BACKGROUND OF THE INVENTION

1. Field of the Invention

The present invention relates generally to the process of manufacturing compositions of solid particles comprising a high fraction of liquid, wherein the composition has the material handling characteristics of a composition comprised only of solid particles. More particularly, the present invention relates to the loading of various liquid substances onto solid carrier particles less than 100 nm in size, wherein the particles are discreetly loaded with more than 60% by weight, of a liquid, forming a composition that retains the characteristics of a dry flowable powder that can be readily handled, stored, transported, measured and delivered in many convenient commercial applications.

2. Description of the Related Art

U.S. Pat. No. 4,008,170 to Allan discloses a silica particle having a size range from about 15-20 nm that is capable of absorbing up to 90% of its weight in water without destroying its ability to flow as a powder.

U.S. Pat. No. 3,393,155 to Schutte et al discloses a method for encapsulating water or other aqueous liquid media within a dry coating and network of pyrogenic silica particles, wherein the silica particles have an average equivalent particle diameter below about 50 nm and are capable of encapsulating from 5 to 10 times their weight of an aqueous liquid without changing the fluffy powder characteristics of the silica particles.

H. Lankes et al compare liquid adsorption capacity of various particle carriers, including silica. Particles in the range of 6 μm are coated with a liquid using a technique wherein the liquid and supercritical carbon dioxide form a gas-saturated solution. The solution expands rapidly, forming very fine droplets, which are mixed with the carrier particles. Liquid loadings of as high as 70 mass percent were achieved on silica. Higher loading levels resulted in wet paste. (H. Lankes, et al., in 2001 Proceedings for the International Congress for Particle Technology, Session: Particles in Life Sciences: Food, No. 149.)

U.S. Pat. No. 6,048,557 to Van Den Burg et al discloses a process for preparing polyunsaturated fatty acids (PUFAs)-containing compositions wherein a PUFA liquid is adsorbed onto a solid carrier, such as a powder.

U.S. Pat. Nos. 3,241,520 and 3,253,944 disclose a particle coating method wherein relatively large pellets, granules and particles are suspended in a stream of air while coating material in a liquid form is mixed with the particles.

There is a need in the art for a means of economically handling, preserving, delivering and measuring liquids, both aqueous and nonaqueous liquids such as food oils, in many commercial applications including in the food, pharmaceutical, commercial coatings, lubricants, etc. industries. One such currently employed method involves the loading of liquids onto small particles, which particles, optimally, retain the stability and handling characteristics of solid flowable powders. Further, liquids processed into solid powder form have been found to be less susceptible to deterioration through excessive temperature, volatilization or reaction with oxygen.

Applicant's process and apparatus for the coating of solid particles, as described in WO 97/07879 to Schurr et al has been applied to this need, and it has been found that in some contexts, a much higher level of liquid loading onto particles can be achieved, as compared to other known commercial processes. Particularly, particles less than 100 nanometers can be loaded with liquids to more than 60%, by weight of the total composition, yielding compositions which behave like dry flowable powders. These highly liquid-loaded compositions are then amenable to the advantages of solid processing technically not applicable to liquids, including particle plating, fluid bed processing, pneumatic conveying processing, mechanical mixing and measuring, elutriation, comminution, etc.

Applicants' assiginees' copending, concurrently filed herewith provisional applications having Attorney Docket numbers CL2148, CL2149, CL2150, CL2178 and PTI sp1255 disclose subject matter related to the present application, and are specifically incorporated herein by reference.

U.S. Pat. No. 6,224,939 B1 issued to Cherukuri et al May 1, 2002 describes a method and apparatus for the encapsulation of feedstock, wherein a solid matrix additive is spray injected in a free-flow condition.

Thus, one object of the invention is to provide a process for discreetly loading a solid carrier particle that is less than 100 nm in size, with more than 60%, by weight of the final composition, with a liquid substance, such that the final composition of loaded particles retains the handling characteristics of a solid powder. Another object of the invention is to provide solid carrier particles in the less than 100 nm range which have been highly loaded with nonaqueous liquids, particularly food oils, wherein the particles are stable, and can be readily further processed in commercial applications.

### BRIEF SUMMARY OF THE INVENTION

The present invention is directed to a process for discreetly loading a solid carrier particle having a size less than 100 nm, with a liquid, the process comprising the steps of:
(a) metering a liquid into a flow restrictor;
(b) injecting a gas stream through the flow restrictor concurrently with step (a) to (i) atomize the liquid and (ii) create turbulent flow of the gas stream and the atomized liquid, wherein the gas stream is optionally heated; and
(c) adding the solid carrier particle to the region of turbulent flow concurrently with steps (a) and (b), wherein the solid carrier particle mixes with the atomized liquid to load the solid carrier particle with the liquid,
   wherein such process provides a solid carrier particle discreetly loaded 60% or greater, by total weight of the loaded carrier particle, with liquid.

The present invention is further directed to compositions comprising solid carrier particles less than 100 nm in size that have been discreetly loaded with liquid, wherein said solid carrier particles are loaded 60% or greater, by total weight of the composition, with a liquid, and further wherein said composition has the handling characteristics of a dry flowable powder. In a second aspect of this embodiment of the invention, the loaded carrier particles can be further coated with a functional coating or encapsulated with a suitable encapsulating material.

### BRIEF DESCRIPTION OF THE DRAWING

FIG. 1 is a schematic diagram of the apparatus in accordance with the present invention.

FIG. 2 is a cut-away, expanded, cross-sectional view of the two-phase atomizer portion of the apparatus shown in FIG. 1.

FIG. 3 depicts an alternate configuration of the apparatus shown in FIGS. 1 and 2.

### DETAILED DESCRIPTION OF THE INVENTION

All patents, patent applications, and publications referred to herein are incorporated by reference in their entirety.

In the context of this disclosure, a number of terms shall be utilized.

The term “loading” as used herein refers to the process of applying to the surface of an individual solid carrier particle an amount of liquid such that in a final composition of liquid-loaded carrier particles, the weight of the liquid that has been loaded onto the solid carrier particles will comprise a significant percent of the total weight of the final composition. In Applicants' invention, a high level of liquid loading onto carrier particles has been achieved, wherein compositions of individually, discreetly loaded particles are produced having at least 60% liquid based upon total weight of the final composition. The term “discreetly” has been used by Applicants to describe a characteristic of the loading process of Applicants' invention wherein each particle is individually loaded with liquid, in contrast to methods disclosed in the prior art wherein liquids are simply mixed and stirred together with fine solid particles to achieve a composition wherein the fine solid particles have collectively absorbed the liquid via agglomeration.

The term “coating” as used herein refers to applying to a loaded particle (as defined above) a layer of coating material. The coating may be of any thickness, it is not necessarily uniform, nor is the entire particle surface necessarily covered. As used herein, the term coating does not necessarily imply that the coated particle has been protected from oxidation or diffusion of volatile materials through the coating material. Coating material may, in some instances, be applied to the liquid-loaded particles of the present invention. For example, when the solid carrier particles of the invention are highly loaded with liquids such as food oils, particularly polyunsaturated fatty acids (PUFA's) destined for the food industry, the particles may be further coated with a functional coating to preserve them, or to improve their taste, solubility, wettability, etc. characteristics.

The term “encapsulating” as used herein refers to a process for coating the loaded particle of the invention so that the coating will substantially or completely encase the loaded particle, in such a manner that volatile substances are inhibited from diffusing through the encapsulation material and oxidation of the encapsulated liquid is inhibited. Applicants contemplate that the liquid-loaded particles of the present invention might be encapsulated with any suitable encapsulating material. Particularly with respect to the nonaqueous liquid-loaded particles of the present invention, it is envisioned that where these nonaqueous liquids are food oils, particularly polyunsaturated fatty acids destined for the food industry, the particles could be encapsulated by suitable encapsulating materials to yield highly-loaded particles of polyunsaturated fatty acids that have been encapsulated to prevent oxidation of the fatty acid, thereby preserving taste and freshness.

Materials that can be used in liquid form to load the solid carrier particles of the invention, or to either coat or encapsulate a liquid-loaded particle of the invention, will depend upon the intended application. For example, if the liquid-loaded particle is intended for human consumption then the liquid loading, coating or encapsulating material should be generally recognized as safe (“GRAS”). If the liquid-loaded particle is intended for incorporation into a pet food or animal feed, or a drug formulation, or a nonfood application, then other loading liquids, coatings or encapsulating materials may be suitable and would be subject to other regulatory constraints.

Examples of GRAS loading, coating and encapsulating materials include, but are not limited to, solutions of sweetening agents such as sucrose or maltodextrose, solutions of proteins such as zein, casein, gelatin, soy protein, whey proteins, solutions of fats such as hydrogenated soybean oil, or solutions of an inorganic material such as sodium chloride, or slurries of materials such as titanium dioxide in water. Other liquid loading, coating or encapsulating materials which can be used in the process of the invention may comprise, for example, a sweetening agent, a food flavoring agent or enhancer, a food color, a food aroma agent, an anti-caking agent, an humectant, an antimicrobial agent, an antioxidant, a surface modifying agent, a nutritional supplementing agent, a protein, a carbohydrate, a lipid or a mineral.

Examples of sweetening agents include, but are not limited to, sugar substitutes such as saccharin, cyclamate, monellin, thaumatins, curculin, miraculin, stevioside, phyllodulcin, glycyrrhizin, nitroanilines, dihydrochalcones, dulcin, suosan, guanidines, oximes, oxathiazinone dioxides, aspartame, alitame, and the like. There can also be monosaccharides and oligosaccharides. Examples of monosaccharides include, but are not limited to, galactose, fructose, glucose, sorbose, agatose, tagatose and xylose. As oligosaccharides there can be mentioned, sucrose, lactose, lactulose, maltose, isomaltose, maltulose, saccharose and trehalose. Other sweetening agents that can also be used include, but are not limited to, high fructose corn syrup. Examples of food colors include, but are not limited to, tartrazine, riboflavin, curcumin, zeaxanthin, beta-carotene, bixin, lycopene, canthaxanthin, astaxanthin, beta-apo-8′-carotenal, carmoisine, amaranth, Ponceau 4R (E124), Carmine (E120), anthocyanidin, erythrosine, Red 2G, Indigo Carmine (E132), Patent Blue V (E131), Brilliant blue, chlorophyll, chlorophyllin copper complex, Green S (E142), Black BN (E151), and the like.

Examples of food aroma agents include, but are not limited to, carbonyl compounds, pyranones, furanones, thiols, thioethers, di- and trisulfides, thiophenes, thiazoles, pyrroles, pyridines, pyrazines, phenols, alcohols, hydrocarbons, esters, lactones, terpenes, volatile sulfur compounds and the like. Examples of food flavoring agents or enhancers include, but are not limited to, monosodium glutamate, maltol, 5′-mononucleotides, such as inosine, and the like. Examples of anti-caking agents include, but are not limited to, sodium, potassium, calcium hexacyanoferrate (II), calcium silicate, magnesium silicate, tricalcium phosphate, magnesium carbonate and the like. Examples of humectants include, but are not limited to, 1,2-propanediol, glycerol, manitol, sorbitol and the like.

Examples of antimicrobial agents include, but are not limited to, benzoic acid, PHB esters, sorbic acid, propionic acid, acetic acid, sodium sulfite and sodium metabisulfite, diethyl pyrocarbonate, ethylene oxide, propylene oxide, nitrite, nitrate, antibiotics, diphenyl, o-phenylphenol, thiabendazole and the like. Examples of antioxidant agents include, but are not limited to, tocopherols, 2,6-di-tert-butyl-p-cresol (BHT), tert-butyl-4-hydroxyanisole (BHA), propylgallate, octylgallate, dodecylgallate, ethoxyquin, ascorbyl palmitate, ascorbic acid and the like. Examples of surface modifying agents include, but are not limited to, mono-, diaglycerides and derivatives, sugar esters, sorbitan fatty acid esters, polyoxyethylene sorbitan esters, stearyl-2-lactylate and the like.

Examples of nutritional supplementing agents include, but are not limited to, vitamins group consisting of fat soluble vitamins group consisting of retinol (vit A), calciferol (vit D), tocopherol (vit E), phytomenadione (vit K1), water soluble vitamins group consisting of thiamine (vit B1), riboflavin (vit B2), pyridoxine (vit B6), nicotinamide (niacin), pantothenic acid, biotin, folic acid, cyanocobalamin (vit B12), ascorbic acid (vit C), polyunsaturated fatty acids (PUFA), and the like. Other carbohydrates which can be used include polysaccharides such as agar, alginates, carrageenans, furcellaran, gum arabic, gum ghatti, gum tragacanth, karaya gum, guaran gum, locust bean gum, tamarind flour, arabinogalactan, pectin, starch, modified starches, dextrins, cellulose, cellulose derivatives, hemicelluloses, xanthan gum, scleroglucan, dextran, polyvinyl pyrrolidone and the like.

Examples of lipids include, but are not limited to, saturated and unsaturated fatty acids, mono- and diacylglycerols triacylglycerols, phospholipids, glycolipids, phosphatidyl derivatives, glycerolglycolipids, sphingolipids, lipoproteins, diol lipids, waxes, cutin and the like. Examples of minerals include, but are not limited to, salts of sodium, potassium, magnesium, calcium, chloride, phosphate, iron, copper, zinc, manganese, cobalt, vanadium, chromium, selenium, molybdenum, nickel, boron, silica, silicon, fluorine, iodine, arsenic and the like.

Examples of pharmaceuticals would include liquid formulations of nutriceuticals, vitamins, supplements, minerals, enzymes, probiotics, bronchodilators, anabolic steroids, analeptics, analgesics, proteins, peptides, antibodies, vaccines, anesthetics, antacids, antihelmintics, anti-arrthymics, antibiotics, anticoagulants, anticolonergics, anticonvulsants, antidepressants, antidiabetics, antidiarrheals, anti-emetics, anti-epileptics, antihistamines, antihormones, antihypertensives, anti-inflammatories, antimuscarinics, antimycotics, antineoplastics, anti-obesity drugs, antiprotozoals, antipsychotics, antispasmotics, anti-thrombics, antithyroid drugs, antitussives, antivirals, anxiolytics, astringents, beta-adrenergic receptor blocking drugs, bile acids, bronchospasmolytic drugs, calcium channel blockers, cardiac glycosides, contraceptives, corticosteriods, diagnostics, digestives, diuretics, dopaminergics, electrolytes, emetics, haemostatic drugs, hormones, hormone replacement therapy drugs, hypnotics, hypoglycemic drugs, immunosuppressants, impotence drugs, laxatives, lipid regulators, muscle relaxants, pain relievers, parasympathicolytics, parasympathicomimetics, prostagladins, psychostimulants, sedatives, sex steroids, spasmolytics, sulfonamides, sympathicolytics, sympathicomimetics, sympathomimetics, thyreomimetics, thyreostatic drugs, vasodialators, and xanthines.

The term “oxidation” as used herein refers to the process wherein the atoms in an element lose electrons and the valence of the element is correspondingly increased resulting in destruction of fat soluble vitamins, loss of natural colors, decrease or change in aroma and flavor, and creation of toxic metabolites.

The term “size” as used herein to describe the solid carrier particles refers to the longest diameter or longest axis of the particle being encapsulated, in that it is not an aspect of the invention that the carrier particles be necessarily spherical, or of any particular shape. The term “having a size under 100 nm” when referring to the carrier particles of the invention is determined using a BET gas adsorption measurement for the appropriate solid particle material which has been selected for liquid loading. The BET method is described in Ullmann's Encyclopedia of Industrial Chemistry, 5th edition, Vol. A-20, p. 257, VCH Verlagsgesellshaft mbH, Germany, 1992 and 5th edition, Vol. B-20, p. 40-41, 1988. Additionally, a description of the BET equation is provided in article Size Measurement, Vol. 2, “Surface Area and Pore Size Determination”, 5th edition, by Terence Allen, Chapman & Hall, New York, 1997, pp. 47-57. Further, ASTM methods exist which relate to the measurement of surface area of precipitated silica by BET. The methods are: D1993-91 (1997) Standard Test Method for Precipitated Silica-Surface Area by Multipoint BET Nitrogen Adsorption and D5604-96 (2001) Standard Test Methods for Precipitated Silica-Surface Area by Single Point BET Nitrogen Adsorption Technique (See Brunauer, Emmet, Teller, Journal of the American Chemical Society, Volume 60, 1938, p 309.1). Generally, the surface areas of powders and solids can be calculated using the adsorption of nitrogen at its boiling point via the BET method. The amount of nitrogen adsorbed is measured instrumentally, and the BET equation is used to calculate the amount of nitrogen corresponding to a monolayer for a given sample. Using an area of 16.2 square Angstroms per nitrogen molecule under the adsorption conditions, the surface area per gram of solid is calculated. Surface area standards are run to insure that the reported values are accurate to within a few percent. For non-porous solids (nearly spherical or cubical), the BET surface area can be compared with the size obtained from another technique (e.g. microscopic or particle size analysis). The relationship

$$SA = \frac{6}{ρ * D}$$

where SA is the surface area in m²/g, p the density in g/cc, and D the diameter in microns (μm).

Primary particle size can be measured by statistically sizing the particles making up an agglomerate or flocculate or single particle. Applicants' method uses SEM (scanning electron microscope) for particle visualization and scaled sizing from these images. The Cab-O-Sil grade used herein has monosized primary particles arranged in a floc structure. The primary particles were measured to be 5 nanometers in diameter. The values determined by the SEM microscopy technique referenced above can be verified by an independent measurement using SAX (small angle scattering electron microscopy). This method provides an independent check of the primary particle size of either single particle structures or those that are part of an agglomerate or floc structure.

The term “volatile” as used herein refers to a compound that is readily vaporizable at a relatively low temperature.

The phrase “% weight, by total weight of the particle” or “% weight, by total weight of the composition” means, when referring to a liquid-loaded particle, the percentage by weight of the liquid compared to the weight of the loaded particle. When describing a composition of liquid-loaded particles, the term, “% weight” refers to the percentage by weight of the liquid portion of the composition compared to the total weight of the liquid-loaded particle composition. In other words, loading is defined by mass fraction in % (w/w) units. Thus, the fraction of liquid to the total weight of the loaded composition will be 100× mass of the liquid/mass of the liquid plus mass of the particles.

The term “characteristics of a dry flowable powder”, and “handling characteristics of a dry powder” mean that the liquid-loaded solid carrier particles have the ability to be handled like bulk solid powders, without significant clumping or pasting. The instant invention will yield particles highly loaded with liquid wherein the flowability characteristics of the liquid-loaded composition will be substantially similar to the flowability characteristics of a composition comprising the same particles in non-liquid-loaded form.

The term “liquids” is used herein as that term is used commonly in the scientific art when referring to the “liquid” state of matter (versus a gas or a solid), and includes both aqueous and nonaqueous liquids. The term “aqueous” is also used herein in the manner commonly understood in the art, and refers to liquids comprising some, or all, water. Further, the term “aqueous” as used herein encompasses the usage commonly employed in the art to describe liquids that have the ability to dissolve water-soluble substances. The term “nonaqueous” is also used herein as it is commonly used in the art, to describe those liquids which have the ability to dissolve non-water-soluble substances. The term “liquid loading” as used in the invention describes the process of applying a substance in its liquid form to the solid carrier particle. The substance may be one that is liquid at room temperature, or alternatively, it may be one that is heated above its melting temperature upon delivery into the loading apparatus, such that it is in liquid or molten form during the loading process, but will then solidify subsequent to the loading process when the ambient temperature of the carrier particle falls below the melting temperature of the substance that has been loaded. In either case, even when the liquid loading material remains in liquid form after the loading process, the composition of loaded particles of the invention will retain the characteristics of a dry flowable powder.

Preferred liquids useful herein to load onto solid carrier particles include, for example, the following substances: oils, fats and lipids, molten polymeric substances, solutions of proteins, carbohydrates, sugars, salts, and minerals, and also organic liquid solvents such as isopropanol, ethanol, acetone, diethyl ether, benzene, etc. Also, aqueous or nonaqueous solutions of pharmaceutical and nutraceutical compounds are included as liquids that could be loaded onto carrier particles. Neat forms of pharmaceutical and nutraceutical compounds are also included, in the form of a melt which can be loaded onto carrier particles at a temperature above the melting point of the neat pharmaceutical or nutraceutical substance. Polyunsaturated fatty acids (PUFA) are particularly preferred nonaqueous liquid embodiments of the invention. Any PUFA can be used to practice the invention, including gamma-linolenic acid (GLA), dihomo-gamma-linolenic acid, arachidonic acid (ARA), docosahexaenoic acid (DHA) and/or eicosapentaenoic acid (EPA).

Suitable carrier particles that can be used in the process of the invention, or the compositions of the invention, include any solid carrier particle under 100 nm that is a solid at the time of liquid loading. The preferred range of solid carrier particle will be under 25 nm, in that generally smaller particles will have the ability to be loaded with liquid to a higher percentage. Particularly preferred embodiments of the carrier particle include fumed silicas and titanium dioxide. Other examples include zeolites, alumina, carbon nanotubes, carbon black, activated carbon, and pigments. Applicants are aware that the state of the art in “nano-sizing” various materials is evolving rapidly, and that concurrent with this evolution more and more substances will become available as suitable solid carrier particles for use in the instant invention. Thus, any solid carrier particle under 100 nm is envisioned to be within the metes and bounds of Applicants' invention. If the solid carrier particle is intended for human consumption Applicants anticipate that such carrier particle material should be generally recognized as safe (“GRAS”). If the solid carrier particle is destined for use in the pharmaceutical industry, the particle may be comprised of, for example, particles less than 100 nm of vitamins, supplements, minerals, enzymes, proteins, peptides, antibodies, vaccines, probiotics, bronchodilators, anabolic steroids, analeptics, analgesics, anesthetics, antacids, antihelmintics, anti-arrthymics, antibiotics, anticoagulants, anticolonergics, anticonvulsants, antidepressants, antidiabetics, antidiarrheals, anti-emetics, anti-epileptics, antihistamines, antihormones, antihypertensives, anti-inflammatories, antimuscarinics, antimycotics, antineoplastics, anti-obesity drugs, antiprotozoals, antipsychotics, antispasmotics, anti-thrombics, antithyroid drugs, antitussives, antivirals, anxiolytics, astringents, beta-adrenergic receptor blocking drugs, bile acids, bronchospasmolytic drugs, calcium channel blockers, cardiac glycosides, contraceptives, corticosteriods, diagnostics, digestives, diuretics, dopaminergics, electrolytes, emetics, haemostatic drugs, hormones, hormone replacement therapy drugs, hypnotics, hypoglycemic drugs, immunosuppressants, impotence drugs, laxatives, lipid regulators, muscle relaxants, pain relievers, parasympathicolytics, parasympathicomimetics, prostagladins, psychostimulants, sedatives, sex steroids, spasmolytics, sulfonamides, sympathicolytics, sympathicomimetics, sympathomimetics, thyreomimetics, thyreostatic drugs, vasodialators, and xanthines.

There are several benefits of the instant process over other commercial liquid loading methods. Applicants believe the process of the instant invention is more cost efficient than currently conducted liquid loading processes because the process utilizes smaller amounts of ingredients in producing the ultimately desired loaded particle. Further, the process is more energy efficient because the residence time of the particle within the loading area of the apparatus is minimal. Further, in one particularly important aspect, the instant process has the flexibility to be operated successively as a batch process with easily modified batch volumes and batch time periods. The flexibility that is inherent in the operation of the apparatus and process of the invention can result in production of highly liquid-loaded carrier particles having carefully-controlled and unique characteristics. For example, concentration values of the liquid, flow rates of the solid particle feed and the liquid feed, ratios of the liquid feed to solid feeds, and temperature and velocity of the gas streams can all be easily varied to yield liquid-loaded particles with particular desired characteristics. An apparatus used to practice the process of this invention is generally described in commonly owned PCT application WO 97/07879.

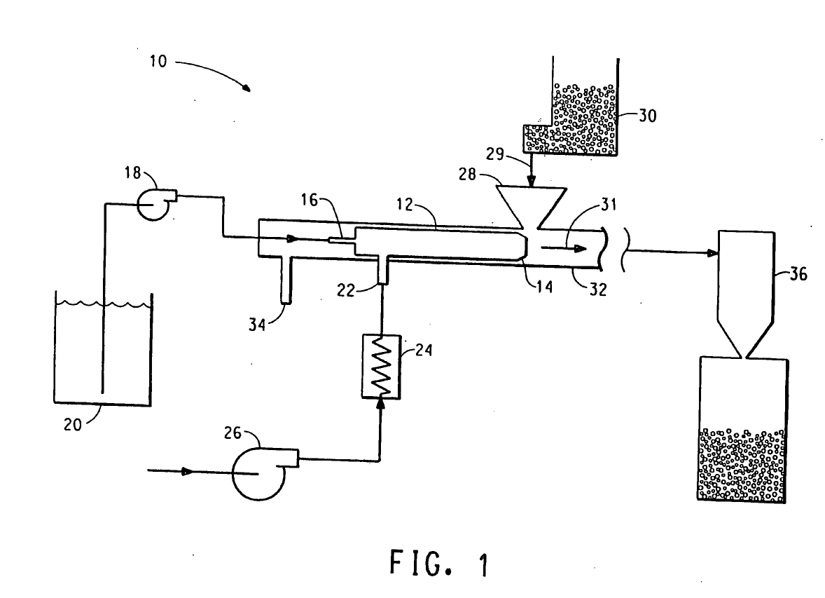

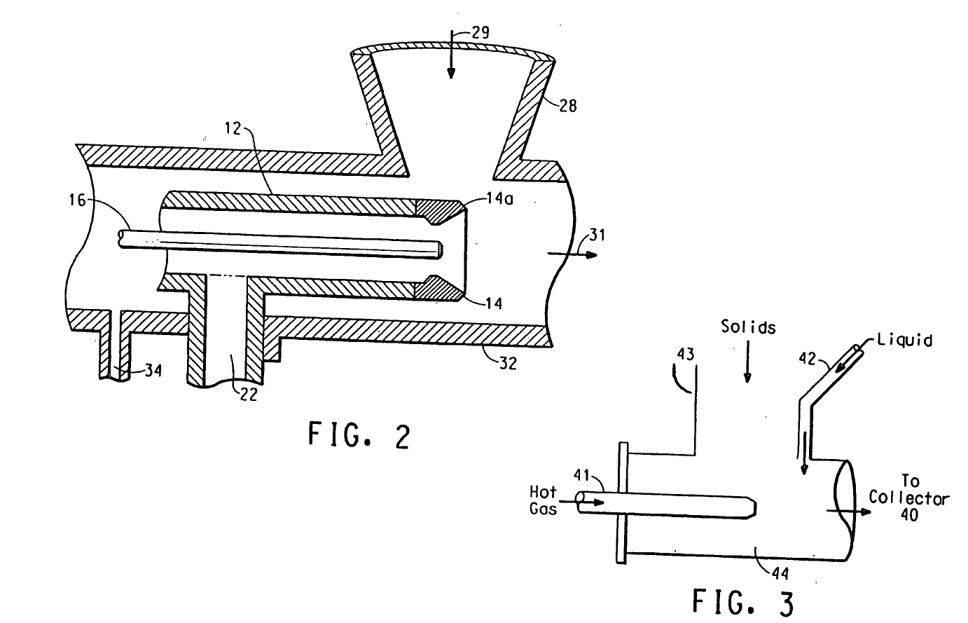

An apparatus according to the present invention is shown generally at 10 in FIG. 1. The apparatus and general process of the present invention can be utilized for liquid loading of solid carrier particles, and further, it can be used to subsequently coat the loaded particles with a functional coating, or to encapsulate the loaded particles. The apparatus comprises a first chamber, shown at 12 in FIGS. 1 and 2. A flow restrictor 14 is disposed at one end of the first chamber. The flow restrictor is typically disposed at the downstream end of the first chamber, as shown in FIGS. 1 and 2. Flow restrictor 14 has an outlet end 14a, as shown in detailed view of FIG. 2. Although the flow restrictor is shown as a different element from the first chamber, it may be formed integrally therewith, if desired. The flow restrictor of the present invention may have various configurations, as long as it serves to restrict flow and thereby increase the pressure of the fluid passing through it. Typically, the flow restrictor of the present invention is a nozzle.

A first, or liquid, inlet line 16 as show in FIGS. 1 and 2 is disposed in fluid communication with the first chamber for metering a liquid composition into the chamber. Liquid inlet line 16 meters the liquid composition into the first chamber 12 in the outlet flow restrictor 14, and preferably in the center of the flow restrictor when viewed along the axial length thereof. The liquid composition is metered through liquid inlet line 16 by a metering pump 18 from a storage container 20 containing the liquid composition as shown in FIG. 1.

The liquid loading composition may be a pure liquid, a solution, where one substance is mixed into or is dissolved in a liquid, a slurry, a melt, or an emulsion. It should be noted that when the liquid composition is a melt, storage container 20 must be heated to a temperature above the melt temperature of the liquid composition, but below the boiling point, in order to maintain the liquid composition in melt form.

The disclosed apparatus for loading a particle further includes a second, or gas, inlet line 22 disposed in fluid communication with the first chamber as shown in FIGS. 1 and 2. Generally, the gas inlet line should be disposed in fluid communication with the first chamber upstream of the flow restrictor. Gas inlet line 22 injects a first gas stream through the flow restrictor to create a turbulent flow of the gas stream, termed herein the zone of turbulence, at the outlet of the flow restrictor. The turbulence subjects the liquid composition to shear forces that atomize the liquid composition.

The first gas stream should have a stagnation pressure sufficient to accelerate the gas to at least one-half the velocity of sound, or greater, prior to entering the flow restrictor to ensure that a turbulent flow of gas of sufficient intensity will be formed at the outlet of the flow restrictor. The velocity of sound for a particular gas stream, e.g., air or nitrogen, will be dependent on the temperature of the gas stream. This is expressed by the equation for the speed of sound, C:
C=\sqrt{kgRT}
where:
k=ratio of specific heat for the gas
g=acceleration of gravity
R=universal gas constant
T=absolute temperature of the gas

Thus, the acceleration of the first gas stream is dependent on the temperature of the gas stream.

As noted above, it is the pressurized gas that causes the atomization of the liquid composition. The pressure of the liquid composition in the liquid inlet line just needs to be enough to overcome the system pressure of the gas stream. It is preferable that the liquid inlet line has an extended axial length before the zone of turbulence. If the liquid inlet line is too short, the flow restrictor becomes plugged.

The apparatus of the present invention also comprises means disposed in the second inlet line and upstream of the flow restrictor for optionally heating the first gas stream prior to injection through the flow restrictor. Preferably, the heating means comprises a heater 24 as shown in FIG. 1. Alternatively, the heating means may comprise a heat exchanger, a resistance heater, an electric heater, or any type of heating device. Heater 24 is disposed in second inlet line 22. A pump 26 as shown in FIG. 1 conveys the first gas stream through heater 24 and into first chamber 12. When a melt is used as the liquid loading material, the gas stream can have a temperature either above or below the temperature of the melt. When using a melt, it is also helpful if auxiliary heat is provided to the first inlet line that supplies the melt prior to injection, to prevent pluggage of the line.

The apparatus of the present invention further includes a hopper 28 as shown in FIGS. 1 and 2. Hopper 28 introduces a particle to the zone of turbulence. It is preferable that the outlet end of the flow restrictor is positioned in the first chamber beneath the hopper at the centerline of the hopper. This serves to ensure that the particles are introduced directly into the zone of turbulence. This is important because, as noted above, the turbulence subjects the liquid composition to shear forces that atomize the liquid composition. It also increases operability by providing a configuration for feeding the particles most easily. In addition, the shear forces disperse and mix the atomized liquid composition with the particles, which allows the particles to be encapsulated. Hopper 28 may be fed directly from a storage container 30 as shown by arrow 29 in FIG. 1. The hopper of the present invention may include a metering device for accurately metering the particles at a particular ratio to the liquid feed from liquid inlet line 16 into the zone of turbulence. This metering establishes the level of encapsulation on the particle. Typically, the hopper of the present invention is open to the atmosphere. When a melt is used, it is preferred that the particles are at ambient temperature because this facilitates solidification of the melt after the melt that is initially at a higher temperature loads the particle in the zone of turbulence.

The apparatus of the present invention may further include a second chamber 32 surrounding the first chamber as shown in FIGS. 1 and 2. In addition, the second chamber encloses the region of turbulent flow. Second chamber 32 has an inlet 34 for introducing a second gas stream into the second chamber. The inlet of the second chamber is preferably positioned at or near the upstream end of second chamber 32. The outlet of second chamber 32 is connected to a collection container, such as that shown at 36 in FIG. 1. The second gas stream acts to reduce any tendency for recirculation within the region of turbulent flow, as the second gas stream cools and conveys the loaded particles toward the collection container as illustrated by arrow 31 in FIG. 2. In particular, when a solution or slurry is used, the solid of the solution or slurry cools between the zone of turbulence and container so that by the time the particle reaches the container, a solidified liquid comprising the solid of the solution or slurry is formed on the particle. When a melt is used, the liquid composition cools in the zone of turbulence so that by the time the particle reaches the container, a solidified liquid comprising the melt is formed on the particle. The first gas stream, as well as the second gas stream, is vented through the top of collection container 36.

For the configuration as shown in FIGS. 1 and 2, inlet 34 may be connected to a blower, not shown, which supplies the second gas stream to the second chamber. The blower and second chamber 32 may be eliminated, however, and the first gas stream may be used to cool the particles and to convey them to container 36. In this case, the solid from the solution, slurry, or melt cools and solidifies on the particle in the atmosphere between the zone of turbulence and the collection container, and the loaded particles fall into collection container 36.

It is preferable that the axial length of the zone of turbulence is about ten times the diameter of the second chamber. This allows the pressure at the outlet of the flow restrictor to be at a minimum. Particles are fed into second chamber 32 as shown in FIGS. 1 and 2 near the outlet of the flow restrictor, which is preferably positioned at the center line of the hopper. If the pressure at the outlet is too great, the particles will back flow into the hopper.

The pressure of the second gas stream must be sufficient to assist in conveying the loaded particles from the zone of turbulence to the collection zone, but should be at lower than the pressure of the first gas stream. This is because a high relative velocity difference between the first gas stream and the second gas stream produces a sufficient degree of turbulence to load the particles.

It should be noted that the process of the present invention may be practiced using the apparatus illustrated in FIGS. 1, 2, and 3, although it should be understood that the process of the present invention is not limited to the illustrated apparatus. Moreover, it should be noted that while one pass, or cycle, of the process of the present invention may substantially or completely load the particle, more than one pass may be used to load additional liquid onto to the particle, depending on the final percentage loading desired.

The process comprises the steps of metering a liquid composition into a flow restrictor, such as flow restrictor 14 as shown in FIGS. 1 and 2. As described above for the apparatus, the liquid composition may be a solution, slurry, emulsion, or melt.

The process of the present invention further comprises injecting a gas stream, for instance from a gas inlet line such as that shown at 22 in FIGS. 1 and 2, through the flow restrictor concurrently with metering the liquid composition into the flow restrictor, to create a zone of turbulence at the outlet of the flow restrictor. The shear in the zone of turbulence atomizes the liquid composition.

The gas stream is heated prior to injecting it through the flow restrictor. The gas stream may be heated by a heater, such as heater 24 as shown in FIG. 1. As noted above for the apparatus, when the liquid composition is a solution or slurry, the gas stream is heated to a temperature sufficient to vaporize the liquid of the solution or slurry and to leave the solid of the solution or slurry remaining. When the liquid composition is a melt, the gas stream should be heated to a temperature of about the melt temperature of the liquid composition, to keep the liquid composition, and in particular, the melt, in liquid (i.e., melt) form. As also noted above for the apparatus, when using a melt, it is also helpful if auxiliary heat is provided to the first inlet line that supplies the melt prior to injection, to prevent pluggage of the line.

The process of the present invention also comprises the step of adding a particle to the zone of turbulence concurrently with the metering of the liquid composition and the injection of the gas stream. This mixes the particle with the atomized liquid composition at the zone of turbulence. This mixing at the zone of turbulence loads the particle with the liquid material. The particle is preferably metered in order to control the ratio of the particle and the liquid added at the zone of turbulence. This establishes the level of loading on the particle. When a solution or slurry is used, the heat from the heated gas stream serves to evaporate the liquid of the solution or slurry, leaving the solid of the solution or slurry remaining to encapsulate the particle. The mixing at the zone of turbulence then loads the particle with the remaining solid from the solution or slurry. When a melt is used, the mixing at the zone of turbulence loads the particle with the melt. As noted above, the zone of turbulence is formed by the action of injecting the gas at high pressure through the flow restrictor. As discussed above with respect to the apparatus, it is preferable that the gas stream is accelerated to at least about one-half the velocity of sound prior to injection to ensure that a zone of turbulence of sufficient intensity will be formed at the outlet of the flow restrictor.

The residence time of the particles in the zone of turbulence is determined by the geometry of the first chamber and the amount of gas injected from the gas inlet line. The average residence time of the particle within the zone of turbulence is preferably less than 250 milliseconds. More preferably, the average residence time of the particle within the zone of turbulence is in the range of 25 to 250 milliseconds. Short residence times can be achieved because of the action of the zone of turbulence. The short residence times make the process of the present invention advantageous compared to conventional loading processes because the time, and hence, the cost of loading particles, are reduced. Further, the present invention can load particles of a significantly smaller size compared to processes in the prior art. Typically, the particles are fed from a hopper, such as hopper 28 as shown in FIGS. 1 and 2, which is open to the atmosphere. As noted above for the apparatus, when the liquid composition is a melt, it is preferred that the particles be at ambient temperature because this will facilitate solidification of the melt after the melt (which is initially at a higher temperature) loads the particle in the zone of turbulence.

The process of the present invention may further comprise the step of adding another gas stream upstream of the zone of turbulence for cooling and conveying the loaded particle. This other gas stream is added through a chamber, such as second chamber 32 as shown in FIGS. 1 and 2. As explained above for the apparatus, the pressure of the second gas stream must be sufficient to assist in conveying the loaded particles from the zone of turbulence to the collection container, but should be at lower than the pressure of the first gas stream in order to achieve encapsulation. When a solution or slurry is used, the solid of the solution or slurry cools and solidifies on the particle in the second chamber between the zone of turbulence and a collection container, such as collection zone 36b as described above. When a melt is used, the melt cools and solidifies on the particle in the second chamber between the zone of turbulence and the collection container. When a second chamber is not included, the solid or the melt cools and solidifies on the particle in the atmosphere between the zone of turbulence and the collection container, and the loaded particles fall into the container.

The loading materials are liquid in nature and can be single compositions or chemical compositions containing any number of substances. Thus, they may be pure liquids, solutions, suspensions, emulsions, melted polymers, resins, and the like. These materials generally have viscosities in the 1 to 2,000 centipoise range.

The apparatus as shown in FIGS. 1, 2, and 3 can be used for a number of processes. In addition to loading a particle under 100 nm with liquid, another process is that of encapsulating or coating a previously liquid-loaded solid carrier particle with surface modifiers, sweeteners, protectant coatings, flavorings, pharmaceutical actives, colorants, and the like. In these processes, the liquid-loaded particle enters the apparatus and the material that will be used to encapsulate or coat the solid particles is fed into the apparatus through the hopper into the high shear/turbulence zone. The resulting atomized encapsulation or coating material encapsulates or coats the surface of the loaded particle as it is pneumatically transported through the apparatus. The temperature of the process is at least 5° C. higher than the vapor temperature of the solvent at the process operating pressure, so that the volatile materials in the encapsulating or coating mixture (e.g., water) are vaporized within a matter of milliseconds. The encapsulated or coated particle is then transported out of the apparatus in a substantially dry state.

A convective drying process is used for removing residual volatiles that result from putting a solution, slurry, or emulsion coating or encapsulation onto the surface of a loaded particle. Generally, the encapsulated or coated solid particles exit the process as a dry and disperse product having the same particle size as the loaded particle plus the encapsulation or coating thickness. The design of the process precludes wet particles from reaching any wall to which they may stick, which improves the cleanliness of the system, and may also include a recycle system that can reduce any interparticle or particle-to-wall sticking that might otherwise occur. This process may be selected from any number of methods, including but not limited to flash drying, pneumatic conveyor drying, spray drying, or combinations thereof. Residence times for drying are generally less than a minute and preferably in the millisecond time frame.

As shown in FIG. 3, the apparatus of FIGS. 1 and 2 can have an alternate configuration. Solids enter the apparatus through hopper 43. Liquid is added via a liquid inlet tub 42 located at the top of the apparatus so that the liquid exists into the high shear/turbulence zone. Hot gas enters chamber 44 through nozzle 41. Produce outlet from chamber 44 exits to collector 40. This configuration can allow for faster changes of liquid used for encapsulation and is less expensive to maintain.

### EXAMPLES

Unless otherwise specified, all chemicals and reagents were used as received from Aldrich Chemical Company, Milwaukee, Wis.

### Analytical Tests for Examples

Coating levels were determined based on mass balance. Residual moisture analysis was determined using a Cenco moisture balance (CSC Scientific Co., Fairfax Va., USA) with resolution to 0.1% moisture. Cab-O-Sil fumed silica supplied by Cabot Corporation, Boston, Mass. (EH-5, surface area approximately 600 m²/g) was used as the solid carrier particle in the following Examples.

Particle size measurements by BET were obtained by the following. Dinitrogen adsorption/desorption measurements were performed at 77.3° K on Micromeritics ASAP® model 2400/2405 porosimeters (Micromeritics, Inc., Norcross, Ga.). Samples were degassed at 150° C. overnight prior to data collection. Surface area measurements utilized a five-point adsorption isotherm collected over 0.05 to 0.20 p/p₀ and analyzed via the BET method (S. Brunauer, P. H. Emmett and E. Teller, J. Amer. Chem. Soc., 60, 309(1938).

### EXAMPLE 1

### Fumed Silica Loaded with Water

The apparatus shown in FIG. 1 was operated with ambient air at 80 psig (551.6 kPa), and used to load water onto fumed silica. A peristaltic pump was used to meter the water (tap water) and an AccuRate single screw feeder (Schenck Weighing Systems, Whitewater, Wis.) was used to meter the fumed silica. The solids feeder and pump were calibrated, and the calibration was verified by measuring the weight of both the powder and liquid metered to the coating process. The fumed silica was metered into the apparatus at 620 g/min, and the water metered at a rate of 935 g/min. A polyester twill filter bag was used to collect the water-loaded silica particles, which were determined to have 60.1% water by mass balance. Water was not visible on the silica particles by observation alone. The apparent morphology and flow properties of the loaded silica were functionally identical to those of the nonloaded silica.

### EXAMPLE 2

### Fumed Silica Loaded with Vegetable (Soy) Oil

The apparatus shown in FIG. 1 was used to load vegetable (soybean) oil (Crisco®, Procter & Gamble, Cincinnati, Ohio) onto fumed silica. As described in Example 1, the fumed silica was metered into the apparatus at a rate of 620 g/min. The vegetable oil was metered at a rate of 1056 g/min. The resulting particles had 63.0% oil loaded onto the surface as calculated by mass balance. Visual observation did not identify the presence of oil on the surface of the silica. The apparent morphology and flow properties of the loaded silica were functionally identical to those of the nonloaded silica.

### EXAMPLE 3

### Fumed Silica Loaded with PUFA

Fumed silica was loaded with polyunsaturated fatty acid (PUFA) fish oils supplied by Omega Protein, Inc., Houston, Tex., and also by Ocean Nutrition Canada, Ltd. The apparatus shown in FIG. 1 was used with a 0.36-inch diameter nozzle throat, and a 0.25-inch outer diameter (O.D.) stainless steel liquid inlet line. A total of 100 CFM (cubic feet/minute) nitrogen at 80 psig (551.6 kPa) was used. A stream of silica was metered at 180 g/min and the stream of PUFA was metered at 540 g/min. A dry-appearing, free flowing powder was collected. The loading of PUFA was determined to be 75% by weight.

### EXAMPLE 4

### Fumed Silica Loaded with Soy Oil and Coated with Eudragit

The apparatus as in FIG. 1 was operated as described above with fumed silica metered at a rate of 620 g/min, and vegetable oil (soybean oil) (Crisco®, Procter and Gamble, Cincinnati, Ohio) was metered at a rate of 1056 g/min. The loaded silica particles were collected and had a 63% loading based on mass balance. They had the visual appearance of nonloaded silica particles.

The process was repeated to coat the soy oil-loaded silica particles with pH dependent anionic acrylic polymer (Eudragit L30 D55 pH dependent anionic acrylic polymer solubilizing above pH 5.5, from Rohm America, Inc., Piscataway, N.J.). The apparatus as described above was used at 80 psig (551.6 kPa). The soy oil-loaded silica particles were metered to the solids feed of the apparatus at 228 g/min using the Syntron feeder. An aqueous dispersion of 30% anionic acrylic polymer was metered at 60.3 g/min to the liquids feed. The coated particles were collected in a bag filter as dry, free flowing, dispersed particles. A mass balance analysis of this product showed that the soy oil-loaded particles were coated with anionic acrylic polymer at a level of 7.4%.

1. A process for discreetly loading a solid carrier particle having a size less than 100 nm, with a liquid, the process comprising the steps of:
(a) metering a liquid into a flow restrictor;
(b) injecting a gas stream through the flow restrictor concurrently with step (a) to (i) atomize the liquid and (ii) create turbulent flow of the gas stream and the atomized liquid, wherein the gas stream is optionally heated; and
(c) adding the solid carrier particle to the region of turbulent flow concurrently with steps (a) and (b), wherein the solid carrier particle mixes with the atomized liquid to load the solid carrier particle with the liquid,
wherein such process provides a solid carrier particle discreetly loaded 60% or greater, by total weight of the loaded carrier particle, with liquid.

2. The process of claim 1, wherein said solid carrier particle is selected from silicas, titanium dioxide, zeolites, alumina, carbon nanotubes, activated carbon, carbon black and pigments.

3. The process of claim 1 wherein said liquid is an aqueous liquid.

4. The process of claim 1 wherein said liquid is a nonaqueous liquid.

5. The process of claim 1 wherein said liquid is selected from fats, oils, lipids, organic liquid solvents, molten polymers, liquid pharmaceuticals and nutraceuticals, and solutions of proteins, carbohydrates, sugars, salts, and minerals.

6. The process of claim 1, wherein said liquid is selected from polyunsaturated fatty acids.

7. The process of claim 1, wherein said solid carrier particle is silica and said liquid is polyunsaturated fatty acid.

8. The process of claim 1, further comprising repeating steps (a)-(c) at least once wherein the liquid is the same or different.

9. The process of claim 1, further comprising coating the liquid-loaded solid carrier particle of step (c) with a functional coating material, comprising the steps of:
(d) metering a coating liquid into a flow restrictor;
(e) injecting a gas stream through the flow restrictor concurrently with step (a) to (i) atomize the liquid and (ii) create turbulent flow of the gas stream and the atomized coating liquid, wherein the gas stream is optionally heated; and
(f) adding the liquid-loaded solid carrier particle to the region of turbulent flow concurrently with steps (a) and (b), wherein the liquid-loaded solid carrier particle mixes with the atomized coating liquid to coat the liquid-loaded solid carrier particle with the coating liquid,
to provide a liquid-loaded carrier particle coated with a functional coating.

10. The process of claim 9, wherein said functional coating is selected from polyunsaturated fatty acids, hydrogenated soybean oils, liquid sucrose, and solutions of sucrose, maltodextrose, zein, casein, gelatin, soy proteins, whey proteins, and sodium chloride, and slurries of titanium dioxide.

11. The process of claim 9, wherein said functional coating is selected from liquid sweetening agents, food flavoring agents, food flavoring enhancers, food colors, food aroma agents, anti-caking agents, humectants, antimicrobial agents, antioxidants, surface modifying agents, nutritional supplementing agents, proteins, carbohydrates, lipids and minerals.

12. The process of claim 9, wherein said liquid-loaded carrier particle of step (c) is comprised of silica loaded with a polyunsaturated fatty acid, and wherein said functional coating material is a solution of sucrose.

13. The process of claim 1, further comprising encapsulating the liquid-loaded solid carrier particle of step (c) with a liquid encapsulating material, comprising the steps of:
(d) metering a liquid encapsulating material into a flow restrictor;
(e) injecting a gas stream through the flow restrictor concurrently with step (a) to (i) atomize the liquid encapsulating material and (ii) create turbulent flow of the gas stream and the atomized liquid encapsulating material, wherein the gas stream is optionally heated; and
(f) adding the liquid-loaded solid carrier particle to the region of turbulent flow concurrently with steps (a) and (b), wherein the liquid-loaded solid carrier particle mixes with the atomized liquid encapsulating material to encapsulate the liquid-loaded solid carrier particle with the liquid encapsulating material,
to provide an encapsulated liquid-loaded carrier particle.

14. A composition comprising discreetly liquid-loaded solid carrier particles; wherein the solid carrier particles have a size under 100 nm; wherein the liquid loaded onto the solid carrier particles is 60% or greater, by total weight of the composition; and wherein the composition has the handling characteristics of a dry flowable powder.

15. The composition of claim 14, wherein the solid carrier particle is selected from the group consisting of silicas, titanium dioxide, zeolites, alumina, carbon nanotubes, activated carbon, carbon black, and pigments.

16. The composition of claim 14, wherein the solid carrier particle is silica and the nonaqueous liquid is one or more polyunsaturated fatty acid.

17. The composition of claim 16 wherein the polyunsaturated fatty acid is selected from the group consisting of including gamma-linolenic acid (GLA), dihomo-gamma-linolenic acid, arachidonic acid (ARA), docosahexaenoic acid (DHA), eicosapentaenoic acid (EPA), or combinations thereof.

18. A liquid-loaded carrier particle produced by the method of claim 1.

19. A liquid-loaded carrier particle coated having a functional coating, produced by the method of claim 9.

20. An encapsulated liquid-loaded carrier particle produced by the method of claim 13.
